(19) United States
(12) Patent Application Publication
(10) Pub. No.: US 2026/0148399 A1
(43) Pub. Date: May 28, 2026

(54) DEPTH ESTIMATION METHOD, ASSOCIATED COMPUTER PROGRAM AND DEVICE

(71) Applicant: BULL SAS, LES-CLAYES-SOUS-BOIS (FR)

(72) Inventors: Anaïs DRUART, Grenoble (FR); David FRAUX, Echirolles (FR); Sophie GUEGAN MARAT, Revel (FR)

(73) Assignee: BULL SAS, LES-CLAYES-SOUS-BOIS (FR)

(21) Appl. No.: 19/382,560

(22) Filed: Nov. 7, 2025

(30) Foreign Application Priority Data
Nov. 27, 2024 (EP) 24306984.6

(51) Int. Cl. G06T 7/50

(52) U.S. Cl. CPC G06T 7/50; G06T 2207/20081

(57) ABSTRACT

The invention relates to a depth estimation method comprising the steps of:
providing, as input to a depth estimation model (12), an input image representative of a scene, an output of the depth estimation model forming a corresponding depth map; and
saving, in a memory (10), the obtained depth map in association with the input image,
   the depth estimation model (12) having been previously obtained by implementing the steps:
for each of N local nodes, training of a respective local model (20), on the basis of a respective local training dataset (D₁, D_{N}) comprising a plurality of local images each associated with a respective local depth map, a result of the training forming a respective trained local model (22);
calculating the depth estimation model (12) from all or part of the trained local models (22).

This application claims priority to European Patent Application Number 24306984.6, filed 27 Nov. 2024, the specification of which is hereby incorporated herein by reference.

### BACKGROUND OF THE INVENTION

### Field of the Invention

At least one embodiment of the invention relates to a depth estimation method.

At least one embodiment of the invention also relates to a computer program and a device implementing such a method.

At least one embodiment of the invention applies to the field of information technology, and more specifically to computer vision.

### Description of the Related Art

Depth estimation is the task of determining the distance between an object and a sensor from images.

Knowledge of such distances is essential in fields such as robotics, autonomous driving, augmented reality and image reconstruction. This is a crucial task in computer vision.

It is known to train an artificial intelligence model to perform such a depth estimation.

Nevertheless, the performance of such depth estimation models is not entirely satisfactory.

Indeed, the data used to train a depth estimation model are often available in insufficient quantity, and generally suffer from unsatisfactory quality. Depth estimation requires a large quantity of high-quality data. What's more, such data can be costly and difficult to annotate accurately.

In addition, collecting data for training a depth estimation model is generally difficult, as said data is likely to contain sensitive or confidential information.

Finally, the data used to train a depth estimation model are generally representative of scenes whose variability and/or complexity are low, which is detrimental to the performance of the trained model.

A purpose of at least one embodiment of the invention is to overcome at least one of the drawbacks of the prior art.

Another purpose of at least one embodiment of the invention is to provide a depth estimation method that is more efficient than known methods.

### BRIEF SUMMARY OF THE INVENTION

To this end, at least one embodiment of the invention relates to a method of the aforementioned type, implemented by computer and comprising the steps of:
providing, as input to a depth estimation model, an input image representative of an input scene,
an output of the depth estimation model forming a depth map comprising, for each pixel of the input image, a value indicative of a depth, in the input scene, of the point in the input scene associated with said pixel; and
storing the obtained depth map, in association with the input image, in a memory,
   the depth estimation model having been previously obtained by implementing the steps:
for each of N local nodes, N being a non-zero natural number, training a respective local model, based on a respective local training dataset, each local model being a copy of a same initial depth estimation model, each local training dataset comprising a plurality of training pairs, each training pair comprising:
   a local image, representative of a corresponding scene; and
   a respective local depth map, forming an expected output of the local model for said local image as input,
   each local depth map having, for each pixel of the respective local image, a value indicative of a depth, in the corresponding scene, of the point of said scene associated with said pixel,
a training result forming a respective trained local model;
calculating the depth estimation model from all or part of the trained local models.

This way, by training each local model at the corresponding local node, training data is not transferred to the central node, which is good for data confidentiality. In addition, the use of a plurality of local training datasets entails a multitude of sources, and therefore a high variability of the data used to train the local models, which helps the depth estimation model achieve improved performance.

Advantageously, the method according to one or more embodiments of the invention has one or more of the following features, taken in isolation or according to any technically possible combination:
the depth estimation model is equal to a weighted average of the trained local models, a weighting coefficient associated with each trained local model depending on the size of the respective local training dataset;
for each local node, obtaining the respective trained local model comprises implementing a loss function comprising, on the one hand, a fitted scale- and shift-invariant and, on the other hand, a regularization loss;
the fitted scale- and shift-invariant is:

$${L}_{I} ( δ , \hat{δ} ) = {\sum }_{j = 1}^{{U}_{M}} \vert {δ}_{j} - \hat{{δ}_{j}} \vert$$

where:

$$∀ j ∈ 〚 1 , M 〛 , \vert {δ}_{j} - \vert < \vert {δ}_{j + 1} - \vert$$

$${U}_{M} = E ( ρ M )$$

$$δ = \frac{d}{max ( max ( d ) , ε )}$$

$$\hat{δ} = \frac{\hat{d}}{max ( max ( \hat{d} ) , ε )}$$

where:
L_{I} is the fitted scale- and shift-invariant;
d is the local depth map;
\hat{d} is the output of the local model;
ε is a predetermined minimum threshold;
max( . . . ) is the “maximum” operator;
δᵢ is the i-th value of vector δ;
[symbol] is the i-th value of vector \hat{δ};
E( . . . ) is the “integer part” operator;
ρ is a predetermined positive real number less than or equal to 1; and
M is the size of each vector δ and \hat{δ};
the regularization loss is:

$${L}_{R} ( R ) = \frac{1}{M} {\sum }_{k = 1}^{K} {\sum }_{i = 1}^{k} \vert {∇}_{x} {R}_{i}^{k} \vert + \vert {∇}_{y} {R}_{i}^{k} \vert$$

where:

$${R}_{i} = {δ}_{i} -$$

$$δ = \frac{d}{max ( max ( d ) , ε )}$$

$$\hat{δ} = \frac{\hat{d}}{max ( max ( \hat{d} ) , ε )}$$

where:
L_{R} is the fitted scale- and shift-invariant;
d is the local depth map;
\hat{d} is the output of the local model;
ε is a predetermined minimum threshold;
max( . . . ) is the “maximum” operator;
δᵢ is the i-th value of vector δ;
[symbol] is the i-th value of vector \hat{δ};
K is a number of local image resolution levels;
∇ₓ is a spatial derivative in a first direction;
∇_{y} is a spatial derivative in a second direction distinct from the first direction; and
M is the size of each vector δ and \hat{δ};
the loss function is equal to:

$${L}_{α} = {L}_{I} + α {L}_{R}$$

where:
L_{α} is the loss function;
L_{I} is the fitted scale- and shift-invariant;
L_{R} is the regularization loss; and
α is a predetermined real coefficient;
the method comprises, for at least one local node, prior to training of the respective local model:
calculating, from a predetermined three-dimensional scene, at least one synthetic image and, for each synthetic image, of a respective corresponding depth map;
adding each synthetic image and the respective depth map to the respective local training dataset, as a training pair.

According to at least one embodiment of the invention, a computer program is provided which comprises executable instructions, which, when they are executed by a computer, implement the steps of the method as defined above.

The computer program can be in any computer language, such as, for example, in machine language, in C, C++, JAVA, Python, etc.

According to at least one embodiment of the invention, a depth estimation device is proposed, comprising a processing unit and a memory, the memory being configured to store a depth estimation model previously obtained by implementing steps:
for each of N local nodes, N being a non-zero natural number, training a respective local model, based on a respective local training dataset, each local model being a copy of a same initial depth estimation model, each local training dataset comprising a plurality of training pairs, each training pair comprising:
   a local image, representative of a corresponding scene; and
   a respective local depth map, forming an expected output of the local model for said local image as input,
   each local depth map having, for each pixel of the respective local image, a value indicative of a depth, in the corresponding scene, of the point of said scene associated with said pixel,
a training result forming a respective trained local model; and
calculating the depth estimation model from all or part of the trained local models;
   the processing unit being configured to:
provide, as input to a depth estimation model, an input image representative of an input scene,
an output of the depth estimation model forming a depth map comprising, for each pixel of the input image, a value indicative of a depth, in the input scene, of the point in the input scene associated with said pixel; and
store the obtained depth map, in association with the input image, in the memory.

The device according to one or more embodiments of the invention can be any type of apparatus such as a server, a computer, a tablet, a calculator, a processor, a computer chip, programmed to implement the method according to at least one embodiment of the invention, for example by running the computer program according to one or more embodiments of the invention.

### BRIEF DESCRIPTION OF THE DRAWINGS

The one or more embodiments of the invention will be better understood from reading the following description, which is given solely by way of non-limiting example and with reference to the accompanying drawings. These show:

FIG. 1 schematically shows a computing framework according to one or more embodiments of the invention;

FIG. 2 is a flowchart of a depth estimation method according to one or more embodiments of the invention;

FIG. 3 is an example of an image representative of a scene, according to one or more embodiments of the invention;

FIG. 4 is a real depth map corresponding to the image in FIG. 3, according to one or more embodiments of the invention;

FIG. 5 is a depth map corresponding to the image in FIG. 3, and obtained by means of a depth estimation model prior to a training step in the method in FIG. 2, according to one or more embodiments of the invention; and

FIG. 6 is a depth map corresponding to the image in FIG. 3, and obtained by means of a depth estimation model subsequent to the implementation of a training step in the method in FIG. 2, according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to a number of figures.

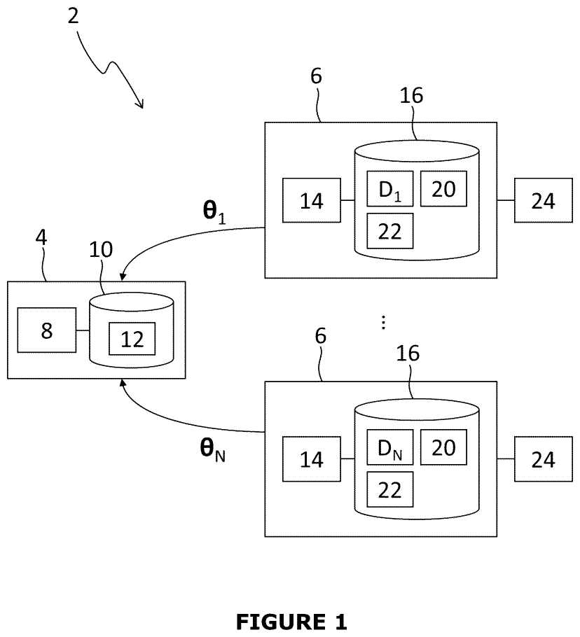

A computing framework 2 is shown in FIG. 1, according to one or more embodiments of the invention.

As depicted in FIG. 1, the computing framework 2 comprises a central node 4.

The computing framework 2 further comprises N local nodes 6, where N is a non-zero natural number. Each local node 6 is connected to the central node 4 via any suitable communication medium.

The central node 4 comprises a central processing unit 8 and a central memory 10 in communication with each other.

In particular, the central memory 10 is configured to store a depth estimation model 12.

In addition, each local node 6 comprises a local processing unit 14 and a local memory 16 in communication with each other.

In particular, for each local node 6, the respective local memory 16 is configured to store a respective local training dataset Dᵢ (i being between 1 and N). In addition, local memory 16 is configured to store a respective local model 20 and trained local model 22.

Preferably, in at least one embodiment, at least one local node 6 is associated with a rendering unit 24 configured to run a 3D engine. In one variant, the same rendering unit 24 is associated with a plurality of local nodes 6.

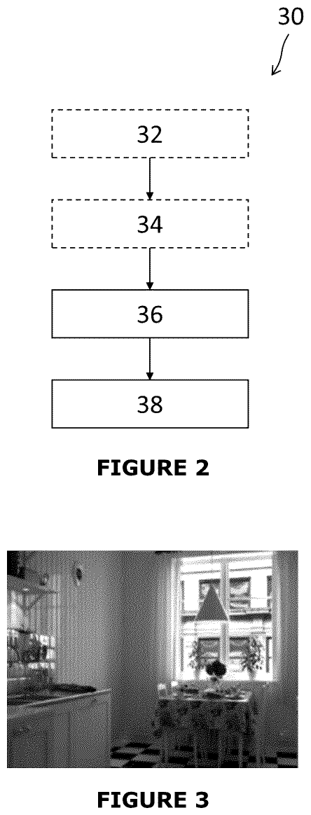

The computing framework 2 is configured to implement a depth estimation method 30 (FIG. 2), according to one or more embodiments of the invention.

The features of each element 4, 6 of the computing framework 2 will be clearer from the description of said depth estimation method 30.

As shown in FIG. 2, according to one or more embodiments of the invention, the depth estimation method 30 comprises a a depth map calculation step 36 (called “calculation step”) and a storing step 38.

Advantageously, the depth estimation method 30 also includes a step 34 for obtaining the depth estimation model 12 (referred to as “obtaining step”), prior to the calculation step 36.

Preferably, in this case, by way of at least one embodiment, the depth estimation method 30 also includes a training set generation step 32 (referred to as “generation step”), prior to the obtaining step 34.

### Generation Step 32

Preferably, in at least one embodiment, each local node 6 is configured to save the respective local training dataset Dᵢ in the corresponding local memory 16 during the generation step 32.

For each local node 6, the respective local training dataset Dᵢ comprises a plurality of training pairs, each comprising an image (known as a “local image”) and a respective depth map (known as a “local depth map”).

More precisely, each local image is representative of a scene (real or virtual) seen from an observation point. In addition, the local depth map associated with said local image comprises, for each pixel of the local image, a depth value indicative of a depth, in the scene represented on the local image, of the point of said scene associated with said pixel, that is a distance from the observation point.

An example of such an image is shown in FIG. 3, according to one or more embodiments of the invention.

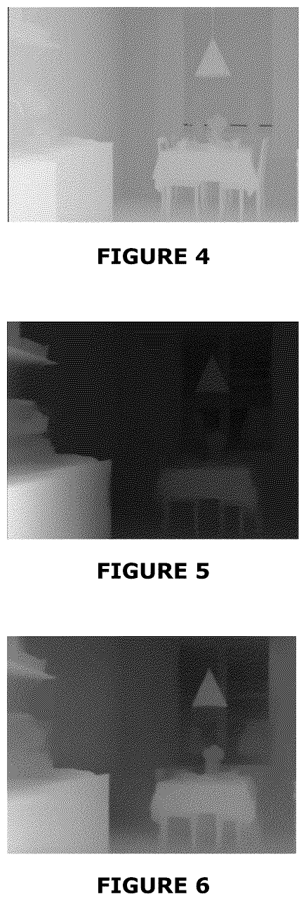

FIG. 4 also shows the depth map associated with the image in FIG. 3, according to one or more embodiments of the invention. More specifically, the image zones associated with the objects closest to the observation point correspond to the lightest areas of the depth map in FIG. 4, according to one or more embodiments of the invention.

By way of example, at least one local image is a real image, in particular from a predetermined bank of real images including, for each real image, the corresponding depth map. Such a real image bank is, for example, the DIODE image bank, or the NYUv2 image bank.

The DIODE image bank is described by Igor Vasiljevic et al. in the digital preprint “DIODE: A Dense Indoor and Outdoor DEpth Dataset”, referenced arXiv:1908.00463. The DIODE image bank includes images representative of indoor and outdoor scenes.

In addition, the NYUv2 image bank is described by Nathan Silberman et al. in the digital publication “Indoor Segmentation and Support Inference from RGBD Images”, referenced Computer Vision-ECCV 2012, Lecture Notes in Computer Science, vol 7576. The NYUv2 image bank comprises images representative of indoor environments.

Alternatively, or additionally, at least one local image is a synthesized image, for example from a predetermined bank of synthesized images comprising, for each synthesized image, the corresponding depth map. An example of such an image bank is, for instance, the Hypersim image bank.

The Hypersim image bank is described by Mike Roberts et al. in the digital preprint “Hypersim: A Photorealistic Synthetic Dataset for Holistic Indoor Scene Understanding”, referenced arXiv:2011.02523.

Alternatively, or additionally, at least one local image is a synthesized image generated by a rendering unit 24.

In this case, for each local node 6 associated with a rendering unit 24, the corresponding rendering unit 24 is configured to implement the 3D engine in order to calculate, during the generation step 32, at least one synthetic image from at least one predetermined three-dimensional scene. For example, each three-dimensional scene has been previously generated by a user.

In this case, each local image is representative of the three-dimensional scene seen from a corresponding virtual observation point.

In addition, the rendering unit 24 is configured to generate the respective depth map for each calculated synthetic image.

Preferably, in at least one embodiment, the rendering unit 24 is configured to normalize the generated depth map, so that each depth value is a positive real number between 0 and 1.

Such normalization corresponds to a step wherein the values of a given depth map are divided by the largest value of said depth map. As a result, the farthest point in the three-dimensional scene from the virtual observation point is assigned the value 1.

Preferably, in at least one embodiment, for each local node 6, the local processing unit 14 is configured to normalize, during the generation step 32, each depth map of each training pair of the corresponding local training dataset. As a result, when the generation step is completed, each depth value is a positive real number between 0 and 1 (the value 1 being associated with the point furthest from the observation point in each scene).

As a result, a depth estimation model trained on the basis of such normalized depth maps leads to a relative depth estimate (as opposed to an absolute depth estimate, indicating the actual distance between the object under consideration and the observation point).

### Obtaining Step 34

Preferably in at least one embodiment, for each local node 6, the local processing unit 14 is configured to train a respective local model 20, based on a respective local training dataset Dᵢ, during the obtaining step 34.

Each local model 20 is a copy of the same initial depth estimation model. In addition, each local model 20 is stored in the respective local node 6.

For example, the initial depth estimation model is the MiDaS model, described by Reiner Birkl et al. in the digital preprint “MiDaS v3.1—A Model Zoo for Robust Monocular Relative Depth Estimation”, referenced arXiv:2307.14460.

FIG. 5 shows the depth map calculated by such a pre-trained model for the image in FIG. 3 as input, according to one or more embodiments of the invention. This figure shows that the model's performance is inadequate, as the estimated depths are very different from those on the reference depth map (FIG. 4).

More precisely, during training, for each training pair, the respective local depth map forms an expected output of the local model 20 for the respective local image taken as input to said local model 20.

Advantageously, in this case, the local processing unit 14 is configured to implement a loss function comprising an fitted scale- and shift-invariant term and a regularization loss. Such a loss function is particularly suitable for relative depth estimation.

In particular, the loss function is equal to:

$${L}_{α} = {L}_{I} + α {L}_{R}$$

where:
L_{α} is the loss function;
L_{I} is the fitted scale- and shift-invariant term;
L_{R} is the regularization loss; and
α is a pre-determined real coefficient (e.g. equal to 1000, the value experimentally estimated as optimal).

Advantageously, for each local image, the fitted scale- and shift-invariant is:

$${L}_{I} ( δ , \hat{δ} ) = {\sum }_{j = 1}^{{U}_{M}} \vert {δ}_{j} - \vert$$

where:

$$∀ j ∈ 〚 1 , M 〛 , \vert {δ}_{j} - \vert \text{<\textbar} {δ}_{j + 1} - \vert$$

$${U}_{M} = E ( ρ M )$$

$$δ = \frac{d}{max ( max ( d ) , ε )}$$

$$\hat{δ} = \frac{\hat{d}}{max ( max ( \hat{d} ) , ε )}$$

where:
L_{I} is the fitted scale- and shift-invariant;
d is the local depth map;
\hat{d} is the output of the local model;
ε is a predetermined minimum threshold;
max( . . . ) is the “maximum” operator (e.g., equal to 10⁻¹²);
δᵢ is the i-th value of vector δ;
[symbol] is the i-th value of vector \hat{δ};
E( . . . ) is the “integer part” operator;
ρ is a predetermined positive real number less than or equal to 1 (e.g., equal to 0.8); and
M is the size of each vector δ and \hat{δ}.

Advantageously, the regularization loss is, for each local image:

$${L}_{R} ( R ) = \frac{1}{M} {\sum }_{k = 1}^{K} {\sum }_{i = 1}^{k} \vert {∇}_{x} {R}_{i}^{k} \vert + \vert {∇}_{y} {R}_{i}^{k} \vert$$

where:

$${R}_{i} = {δ}_{i} -$$

where:
L_{R} is the regularization loss;
K is a number of local image resolution levels (e.g. equal to 4);
∇ₓ is a spatial derivative in a first direction;
∇_{y} is a spatial derivative in a second direction distinct from the first direction.

The result for each local node 6 is a respective trained local model 22, the result of training the local model 20 on the basis of the respective local training dataset Dᵢ. In other words, the trained local models 22 have the same architecture from one local node 6 to another, but differ in the values θᵢ of their coefficients.

In addition, each local node 6 is configured to transfer the corresponding trained local model 22 to the central node 4 on completion of training.

More precisely, each local node 6 is configured to transfer, to the central node 4, the set θᵢ of values taken by the coefficients of the respective trained local model 22.

In addition, the central processing unit 8 is configured to calculate the depth estimation model 12 from each trained local model 22 received, and more specifically from the values θᵢ of the coefficients of each trained local model 22.

More precisely, the central processing unit 8 is configured to aggregate the trained local models 22 received to obtain the depth estimation model 12.

Preferably, in at least one embodiment, in this case, the central processing unit 8 is configured to calculate the depth estimation model 12 as a weighted average of the trained local models 22. In other words, each coefficient of the depth estimation model 12 has a value equal to the average of the values of the corresponding coefficients of the trained local models 22. Such a calculation implies that the depth estimation model 12 has the same architecture as the trained local models 22 (and therefore the local models 20).

Preferably, in at least one embodiment a weighting coefficient associated with each trained local model 22 depends on the size of the respective local training dataset Dᵢ.

FIG. 6 shows the depth map calculated by such a trained model for the image in FIG. 3 as input, according to one or more embodiments of the invention. This figure shows that the performance of the model trained according to the method of at least one embodiment of the invention is better than that of the initial model, with estimated depths closer to those of the reference depth map (FIG. 4), according to one or more embodiments of the invention.

### Calculation Step 36

The central processing unit 8 is also configured to provide, during the calculation step 36, an input image representative of a scene, known as the “input scene”, as an input to the depth estimation model 12.

In this case, an output of the depth estimation model forms a depth map comprising, for each pixel of the input image, a value indicative of a depth, in the input scene, of the point in the input scene associated with said pixel.

### Storing Step 38

The central processing unit 8 is further configured to, during the storing step 38, store, in the central memory 10, the obtained depth map in association with the input image.

### Operation

The operation of the computing framework 2 will now be described with reference to FIG. 2, according to one or more embodiments of the invention.

Preferably, in at least one embodiment, during the generation step 32, each local node 6 stores, in the respective local memory 16, the respective local training dataset Dᵢ, comprising real and/or synthetic images, each associated with the corresponding depth map.

For example, at least one synthetic image has been previously generated from a three-dimensional scene created by means of a 3D engine running on a rendering unit 24.

In addition, preferably, for each local node 6, the respective local processing unit 14 normalizes each depth map of each training pair of the respective local training dataset Dᵢ.

Then, preferably during the obtaining step 34, for each local node 6, the corresponding local processing unit 14 trains the respective local model 20, based on a respective local training dataset Dᵢ.

The result, at the end of training, is a respective trained local model 22 for each local node 6.

Then, at the end of training, each local node 6 transfers the corresponding trained local model 22 to the central node 4.

Then, the central processing unit 8 of the central node calculates the depth estimation model 12 from each trained local model 22 received.

Then, during the calculation step 36, the central processing unit 8 provides an input image representative of an input scene as input to the depth estimation model 12.

In this case, an output of the depth estimation model 12 forms the depth map calculated for said input image.

Then, during the storing step 38, the central processing unit 8 saves the obtained depth map in the central memory 10, in association with the input image.

Of course, the one or more embodiments of the invention are not limited to the examples disclosed above.

1. A computer-implemented method for generating synthetic images, comprising:
providing, as input to a depth estimation model, an input image representative of an input scene, an output of the depth estimation model forming a depth map comprising, for each pixel of the input image, a value indicative of a depth, in the input scene, of a point in the input scene associated with said each pixel; and
storing, in a memory, the depth map that is formed in association with the input image,
the depth estimation model having been previously obtained by implementing:
for each local node of N local nodes, N being a non-zero natural number, training a respective local model, based on a respective local training dataset (D₁, D_{N}), each local model of said each local node being a copy of a same initial depth estimation model,
each local training dataset comprising a plurality of training pairs, each training pair including:
a local image, representative of a corresponding scene; and
a respective local depth map, forming an expected output of the each local model for said local image as input, each local depth map of said each local training dataset having, for said each pixel of the local image associated therewith, a value indicative of a depth, in a corresponding scene, of the point of said input scene associated with said each pixel,
a training result forming a respective trained local model;
calculating the depth estimation model from all or part of trained local models from each trained local model of said respective trained local model of said each local node.

2. The computer-implemented method according to claim 1, wherein the depth estimation model is equal to a weighted average of the each local model that is trained, a weighting coefficient associated with said each local model that is trained depending on a size of the respective local training dataset (D₁, D_{N}).

3. The computer-implemented method according to claim 1, wherein, for said each local node, obtaining the respective trained local model comprises implementing a loss function comprising, on one hand, a fitted scale- and shift-invariant and, on another hand, a regularization loss.

4. The computer-implemented method according to claim 3, wherein the fitted scale- and shift-invariant is:
$${L}_{I} ( δ , \hat{δ} ) = {\sum }_{j = 1}^{{U}_{M}} \vert {δ}_{j} - {\hat{δ}}_{j} \vert$$
where:
$$∀ j ∈ 〚 1 , M 〛 , \vert {δ}_{j} - {\hat{δ}}_{j} \vert < \vert {δ}_{j + 1} - \vert$$
$${U}_{M} = E ( ρ M )$$
$$δ = \frac{d}{max ( max ( d ) , ε )}$$
$$\hat{δ} = \frac{\hat{d}}{max ( max ( \hat{d} ) , ε )}$$
where:
L_{I} is the fitted scale- and shift-invariant;
d is the respective local depth map;
\hat{d} is the expected output of the each local model;
ε is a predetermined minimum threshold;
max( . . . ) is a maximum operator;
δᵢ is an i-th value of vector δ;
\hat{δ}ᵢ is an i-th value of vector \hat{δ};
E( . . . ) is an integer part operator;
ρ is a predetermined positive real number less than or equal to 1; and
M is a size of each vector δ and \hat{δ}.

5. The computer-implemented method according to claim 3, wherein the regularization loss is:
$${L}_{R} ( R ) = \frac{1}{M} {\sum }_{k = 1}^{K} {\sum }_{i = 1}^{k} \vert {∇}_{x} {R}_{i}^{k} \vert + \vert {∇}_{y} {R}_{i}^{k} \vert$$
where:
$${R}_{i} = {δ}_{i} - {\hat{δ}}_{i}$$
$$δ = \frac{d}{max ( max ( d ) , ε )}$$
$$\hat{δ} = \frac{\hat{d}}{max ( max ( \hat{d} ) , ε )}$$
where:
L_{R} is the regularization loss;
d is the each local depth map;
\hat{d} is the expected output of the each local model;
ε is a predetermined minimum threshold;
max( . . . ) is a maximum operator;
δᵢ is an i-th value of vector δ;
\hat{δ}ᵢ is an i-th value of vector \hat{δ};
K is a number of local image resolution levels;
∇ₓ is a spatial derivative in a first direction;
∇_{y} is a spatial derivative in a second direction distinct from the first direction; and
M is a size of each vector δ and \hat{δ}.

6. The computer-implemented method according to claim 3, wherein the loss function is equal to:
$${L}_{α} = {L}_{I} + α {L}_{R}$$
where:
L_{α} is the loss function;
L_{I} is the fitted scale- and shift-invariant;
L_{R} is the regularization loss; and
α is a predetermined real coefficient.

7. The computer-implemented method according to claim 1, further comprising, for at least one local node, prior to training the respective local model:
calculating, from a predetermined three-dimensional scene, at least one synthetic image and, for each synthetic image, of a respective corresponding depth map;
adding said each synthetic image and the depth map associated therewith to the respective local training dataset, as a training pair.

8. A computer program comprising executable instructions which, when executed by a computer, implement a computer-implemented method for generating synthetic images, comprising:
providing, as input to a depth estimation model, an input image representative of an input scene, an output of the depth estimation model forming a depth map comprising, for each pixel of the input image, a value indicative of a depth, in the input scene, of a point in the input scene associated with said each pixel; and
storing, in a memory, the depth map that is formed in association with the input image,
the depth estimation model having been previously obtained by implementing:
for each local node of N local nodes, N being a non-zero natural number, training a respective local model, based on a respective local training dataset (D1, DN), each local model of said each local node being a copy of a same initial depth estimation model,
each local training dataset comprising a plurality of training pairs each training pair including:
a local image, representative of a corresponding scene; and
a respective local depth map, forming an expected output of the each local model for said local image as input, each local depth map of said each local training dataset having, for said each pixel of the local image associated therewith, a value indicative of a depth, in a corresponding scene, of the point of said input scene associated with said each pixel,
a training result forming a respective trained local model;
calculating the depth estimation model from all or part of trained local models from each trained local model of said respective trained local model of said each local node.

9. A depth estimation device, comprising:
a processing unit and a memory, the memory being configured to store a depth estimation model previously obtained by:
for each local node of N local nodes, N being a non-zero natural number, training a respective local model, based on a respective local training dataset (D₁, D_{N}), each local model being a copy of a same initial depth estimation model,
each local training dataset comprising a plurality of training pairs, each training pair of said plurality of training pairs comprising:
a local image, representative of a corresponding scene; and
a respective local depth map, forming an expected output of the each local model for said local image as input, each local depth map having, for each pixel of the local image associated therewith, a value indicative of a depth, in the corresponding scene, of a point of said corresponding scene associated with said each pixel,
a result of the training forming a respective trained local model; and
calculating the depth estimation model from all or part of trained local models from each trained local model of said respective trained local model of said each local node;
wherein the processing unit is configured to
provide, as input to a depth estimation model, an input image representative of an input scene, an output of the depth estimation model forming a depth map comprising, for said each pixel of the input image, a value indicative of a depth, in the input scene, of the point in the input scene associated with said each pixel; and
store, in the memory, the depth map that is formed in association with the input image.
